(19) United States
(12) Patent Application Publication
(10) Pub. No.: US 2003/0051974 A1
(43) Pub. Date: Mar. 20, 2003

(54) Automated semiconductor processing system

(75) Inventor: Jeffry Davis, Kalispell, MT (US)

Correspondence Address: PERKINS COIE LLP, POST OFFICE BOX 1208, SEATTLE, WA, 98111-1208, US

(73) Assignee: Semitool, Inc.

(21) Appl. No.: 10/200,075

(22) Filed: Jul. 19, 2002

Related U.S. Application Data
(63) Continuation-in-part of application No. 09/612,009, filed on Jul. 7, 2000.
Application No. 09/612,009 is a continuation-in-part of application No. 09/274,511, filed on Mar. 23, 1999, now Pat. No. 6,279,724.
Application No. 09/274,511 is a continuation-in-part of application No. 09/112,259, filed on Jul. 8, 1998, now Pat. No. 6,273,110.
Application No. 09/112,259 is a continuation-in-part of application No. 08/994,737, filed on Dec. 19, 1997, now Pat. No. 6,447,232.
Application No. 08/994,737 is a continuation-in-part of application No. 08/851,480, filed on May 5, 1997, now abandoned.

(51) Int. Cl. B65G 15/64

(52) U.S. Cl. 198/345.3

(57) ABSTRACT

An automated processing system for processing flat workpieces, such as semiconductor wafers, operates by loading the workpieces into a first carrier. A process robot is adapted to engage external features of the first carrier, for lifting and moving the first carrier within the system. The process robot delivers the first carrier holding the wafers of a first size to a process chamber. The first carrier is secured in the process chamber by one or more of the external features of the first carrier. The first carrier has interior features, such as combs and slots, for holding wafers of a different first size. A second carrier has external features which are the same as the external features of the first carrier. The second carrier has inside features which are dimensioned to hold wafers of a second size, different from the first size. The automated processing system can accordingly handle or operate with both the first and second carriers, and thereby process workpieces having different sizes.

This application is a Continuation-in-Part of U.S. patent application Ser. No. 09/612,009 filed Jul. 7, 2000, and now pending, which is a Continuation-in-Part of U.S. patent application Ser. No. 09/274,511, filed Mar. 23, 1999, now U.S. Pat. No. 6,279,724, which is a Continuation-in-Part of U.S. Patent Application Ser. No. 09/112,259, filed Jul. 8, 1998, now U.S. Pat. No. 6,273,110, which is a Continuationin-Part of U.S. patent application Ser. No. 08/994,737, filed Dec. 19, 1997 and now pending, which is a Continuation-in-Part of U.S. patent application Ser. No. 08/851,480, filed May 5, 1997 and now abandoned. Priority to these applications is claimed under 35 USC §120, and these applications are incorporated herein by reference. U.S. patent application Ser. No. 09/611,507 filed Jul. 2, 2000 is also incorporated herein by reference. This Application is also a Continuation-in-Part of U.S. patent application Ser. No. 09/735,154 filed Dec. 12, 2000 and now pending, and Ser. No. 09/907,523, filed Jul. 16, 2001, now pending, both incorporated herein by reference.

The field of the invention is automated processing systems, used for processing semiconductor wafers, hard disk or memory media, semiconductor substrates; optical materials or masks, and similar materials requiring very low levels of contamination, collectively referred to here as “wafers.”

Automated processing systems have improved wafer manufacturing by providing computer control and robotic handling and movement of wafers, during and between various manufacturing steps. While the semiconductor industry is moving towards increasing use of 300 mm diameter wafers (for improved yields, efficiency, and cost savings), other wafer sizes, such as 200 mm, or 150 mm remain in widespread use. Typically, automated processing systems are designed to handle wafers of one specific size. This limits the versatility of such systems. As a result, there is a need for automated processing systems which are able to process and handle wafers of varying sizes.

### SUMMARY OF THE INVENTION

To this end, in a first aspect, an automated processing system operates by loading wafers into a first carrier. A process robot is adapted to engage external features or the outside diameter or surface of the first carrier, for lifting and maneuvering the first carrier within the system. The process robot delivers the first carrier holding the wafers of a first size to a process chamber. The first carrier is secured in the process chamber by external features of the first carrier, including, for example, lugs, ribs, slots, and/or curved outside diameter surfaces. Interior or inside wafer holding features of the first carrier, such as grooves, ribs, slots and/or combs, are dimensioned or adapted to hold wafers of the first size or diameter, e.g., 300 mm.

A second carrier, (or a second set of carriers), has outer or external robot or chamber engagement features which are the same as the external features of the first carrier. Consequently, the process robot and process chambers can also work with, handle or accept the second carrier. However, the second carrier has inside or interior features which are dimensioned or adapted to hold wafers of a second size, different from the first size. As a result, the automated processing system can process wafers of varying sizes, via use of varying sets of carriers, all having common outer engagement features (i.e., outer engagement features of the same dimensions, position and shape), and having varying inside wafer holding features.

In a second aspect, an end effector of a transfer robot in the automated processing system has two or more sets of wafer edge grip positions. An edge grip component, such as a pin, post, wedge, grommet, fork, or other component for engaging an edge of the wafer, is located at each of the edge grip positions. A first set of grip positions are used for handling wafers of the first size. A second set of grip positions is used for handling wafers of the second size. As a result, the transfer robot can move wafers of either size between a wafer container at a docking station and a carrier at a transfer station. The automated processing system can accordingly be used to process wafers of varying size, by use of different sets of carriers having common outside features and varying inside wafer holding features. The system, which is preferably electronically or computer controlled, can be switched over to handle wafers of different sizes, via changing the carriers, and by a programming selection or change.

Other objects, features and advantages will appear hereinafter. The various features described among the embodiments may of course be used individually or in differing combinations. The invention resides not only in the systems and components described, but also in the subcombinations and subsystems described, including the process and transfer robots, the carriers themselves, as well as in the methods.

### BRIEF DESCRIPTION OF THE DRAWINGS

In the drawings, wherein the same reference number denotes the same element throughout the several views:

FIG. 1 is a perspective view of air automated processing system, with surfaces or walls removed for clarity of illustration.

FIG. 2 is a top, back and left side perspective view of the system of FIG. 1.

FIG. 3 is a left side elevation view thereof.

FIG. 4 is a right side elevation view thereof.

FIG. 5 is a plan view thereof.

FIG. 6 is a front view thereof.

FIG. 7 is a perspective view of another processing system.

FIG. 8 is a plan view of the system shown in FIG. 6.

FIG. 9 is a perspective view of a first carrier for use in the system shown in FIGS. 1 or 7.

FIG. 10 is a rear end view thereof.

FIG. 11 is a section view of the carrier shown in FIGS. 9 and 10, (loaded with wafers), taken along line 11-11 of FIG. 10.

FIG. 12 is an enlarged detail view of the lower left area of FIG. 11, and showing the groove or slot angle \hat{-} of 8-15; 10-14, or 12 degrees.

FIG. 13 is a perspective view of a second carrier, for holding wafers of a second size, smaller than wafers of the first size.

FIG. 14 is a perspective view of an alternative carrier for holding wafers of the second size.

FIG. 15 is a perspective view of a wafer end effector of a transfer robot for use in the system of FIGS. 1 or 7, for handling wafers, of the first size or the second size.

FIG. 16 is a plan view of the right side arm of the end effector of FIG. 15, showing the wafer edge grip positions, with the left side arm a mirror image of the right side arm.

FIG. 17 is a side view of the transfer robot engaged to a carrier.

FIG. 18 is a front view thereof.

FIG. 19 is a plan view thereof.

FIG. 20 is a perspective view of the carrier end effector shown in FIGS. 17-19.

### DETAILED DESCRIPTION OF THE DRAWINGS

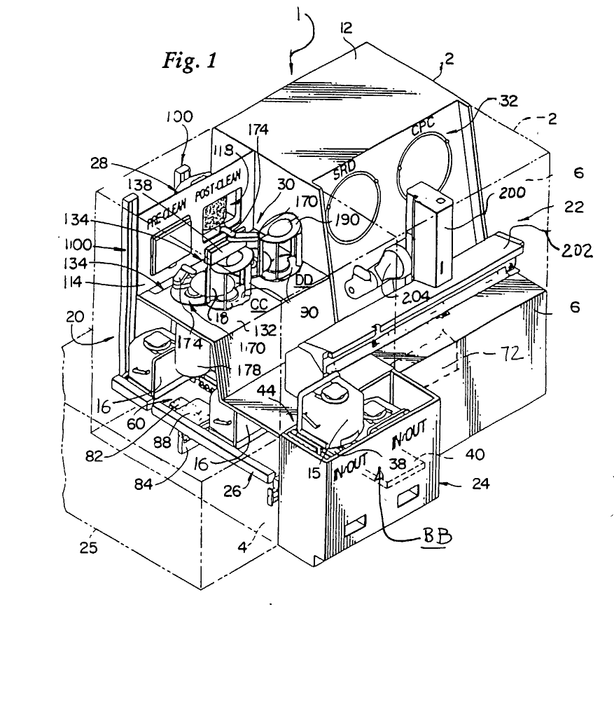

Referring now to FIGS. 1-6, an automated semiconductor processing system 1, has an enclosure 2 preferably having a left side wall 4, right side wall 8, front wall 6, back wall 10, and a top wall 12. For purposes of explanation, the system 1 can be described as having an indexer or work-in-progress (WIP) space or bay 20, and a process space or bay 22, both within the enclosure 2.

The system 1 includes as major subsystems a loader 24, which may be outside of the enclosure 2, and an indexer 26, a docking station 28, a transfer station 30 including a transfer robot 174, a process station 32, and a process robot 200, all within the enclosure 2. The indexer 26 and docking station 28 may be considered as subsystems within the indexer space 20, while the transfer station 30, process station 32 and process robot 200 may be considered as subsystems within the process space 22.

Referring still to FIGS. 1-6, the loader 24 is preferably positioned at the front wall 6, in alignment with the indexer 26. However, alternatively, a loader 25, shown in dotted line in FIG. 1, may be positioned at the left side wall 4, in place of the loader 24.

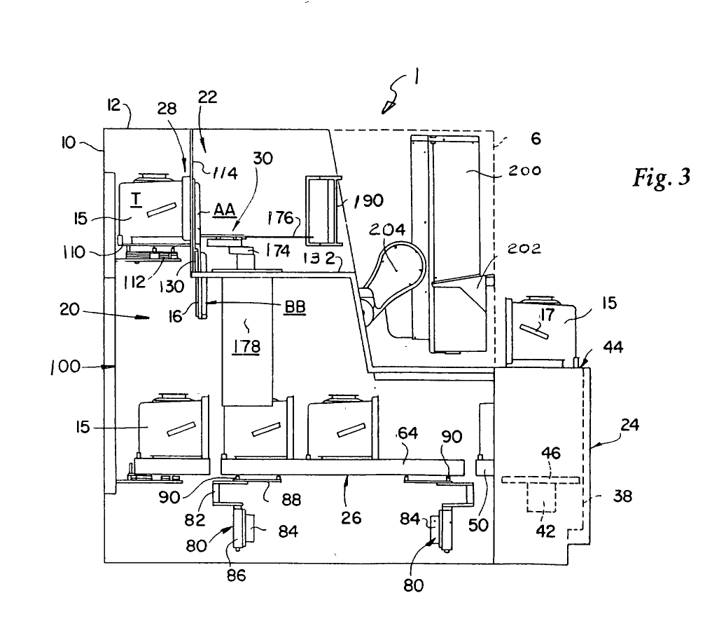

The loader 24 (or 25) has a load or first elevator 38 and an unload or second elevator 40. The elevators 38 and 40 are adapted to receive a closed or sealed pod 15 containing wafers 18, or other similar flat workpiece. The elevators 38 and 40 in the loader 24 move a pod 15 from a load or up position 44, to an indexer or down position 46, as shown in FIG. 3. The pod may be of various designs, (such as a FOUP, FOSBY or SMIF pod or container) available as a standard product from various manufacturers. A pod door 16 (shown in FIGS. 1 and 3) closes off or seals the open front end of the pod 15. The pods 15 are used to store and transport wafers 18, during manufacturing, while protecting the wafers from physical damage and keeping the wafers 18 free of contamination from particles, dust, etc.

In the system shown, the pods 15 are placed onto and removed from the load elevator 38 by hand. The pods 15 have handles 17 ergonomically positioned to better facilitate carrying the pod 15. Consequently, the pods 15 are preferably placed and removed from the elevators 38 and 40 of the loader 24 with the pod door 16 facing the back wall 10. To position the pod 15 so that the wafers 18 within the pod 15 may be accessed within the system 1, the loader 24 includes a pod rotator 42. The pod rotator 42 operates to rotate a pod on the load elevator 38 by 180°, so that the pod door 16 is reoriented towards the front of the system 1. This reorientation by the pod rotator 42 preferably occurs with the pod 15 in the down position 46.

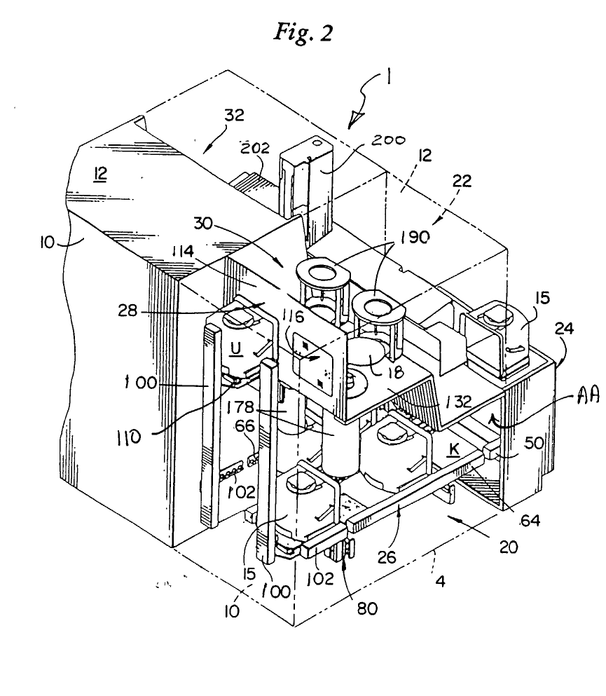

As shown in FIG. 2, the input conveyor 64 is aligned with the loader conveyor 48 associated with the load elevator 38 in the loader 24. Similarly, the output conveyor 66 is aligned with the conveyor 48 associated with the unload elevator 40 in the loader 24. This alignment (in the vertical and lateral directions) allows pods 15 to be moved between the conveyors 48 in the loader 24, and the conveyors 64 and 66 in the indexer 26. The lateral direction is the direction extending between the left side wall 4 and right side wall 8 of the enclosure 2, in a direction perpendicular to those walls. The indexer is described in U.S. Pat. No. 6,279,724, incorporated herein by reference.

Referring to FIGS. 1, 2, and 3, a docking station elevator 100 extends vertically from each of the docking elevator conveyors 102 to a docking station 28 positioned vertically above the indexer 26. Each elevator 100 has an engager plate 110, for engaging a bottom surface of a pod 15, to lift the pod off of the conveyor 102. The engager plate 110 is vertically movable along the elevator 100 from rear positions of the indexer 26. The elevators 100 lift and lower the engager plate 110 via an electrically powered ball screw or equivalent actuators.

Referring to FIG. 3, the engager plate 110 is positioned on an engager actuator 112 which moves the engager plate 110 longitudinally, i.e., in a direction from the front wall 6 to the back wall 10, and perpendicular to those walls.

A docking wall 114 at the docking station 28 and a deck 132 separate the indexer space 20 from the process space 22. The docking wall 114 has openings 116 and 118 aligned with the rear pod positions. Hence, a pod door 16 of a pod 15 on an engager plate 110 lifted by a docking elevator 100, aligns laterally and vertically (but initially not longitudinally) with an opening 116 or 118 in the docking wall 114. After the pod 15 is vertically aligned with an opening 114 or 116, the engager actuator 112 moves the pod forward, so that the front face of the pod contacts the docking wall 114. During other movement of the pod 15 on the elevator 100, the engager actuator 112 is retracted, so that the pod is spaced apart from the docking wall 114 and can be moved vertically without interference with the docking wall 114, or other components.

Referring still to, FIG. 3, a pod door remover 130 is provided at each of the openings 114 and 116 in the docking wall 114, to remove the pod door 16 from a docked pod 15. The pod door remover 130 removes the pod door 16 and lowers it down through a pod door slot 134 in the deck 132. This unseals the pod 15 and moves the pod door 16 out of the way, so that wafers 18 within the pod 15 can be accessed. The design and operation of the pod door remover 130 is set forth in International Patent Application Publication WO99/32381, incorporated herein by reference. In FIG. 3, the pod door remover 130 is shown in the up or closed position (to engage and remove, or replace, a pod door 16) at position M, and is shown in the down or open position, holding a pod door away from the opening 114 or 116, at position BB.

The docking station 28 and transfer station 30 may be characterized as forming two side-by-side parallel rows CC and DD, for purposes of explanation, with the components and operations of the rows being the same. Referring once again to FIGS. 1-6, in rows CC and DD, transfer robots 170 in the transfer station 30 are positioned to reach into docked pods 15, engage wafers 18 in the pods, and transfer the wafers 18 into carriers 190. Each of the transfer robots 170 has an articulated arm 174, and an end effector 176 on the end of the arm 174, with the end effector 176 adapted to engage a single wafer 18. An arm driver 178 is connected to the articulated arm 174, and has one or more motors for driving the arm segments, as controlled by the controller 72.

A reader/scanner 180 is provided in the transfer station 30, to identify individual wafers 18 as they are moved from a pod 15 into a carrier 190.

If desired, a prealigner 181 may be located in the transfer station at a location accessible by a transfer robot 170 so that individual wafers may be appropriately oriented after removal from a pod 15 and before insertion into a carrier 190.

A process robot 200 moves laterally on a rail 202, between the transfer station 30, a first process chamber 230 (such as a spray acid chamber, or a spray solvent chamber) and a second process chamber 220 (such as a spin rinser dryer). Each process chamber 220 and 230 has a rotor 240 adapted to receive a carrier 190 holding wafers 18. The system 1 is preferably configured and dimensioned for processing 300 mm diameter wafers 18. Other types and numbers of process stations may be substituted or added. Additional description of operation of the process robot is in U.S. Pat. No. 5,664,337, incorporated herein by reference.

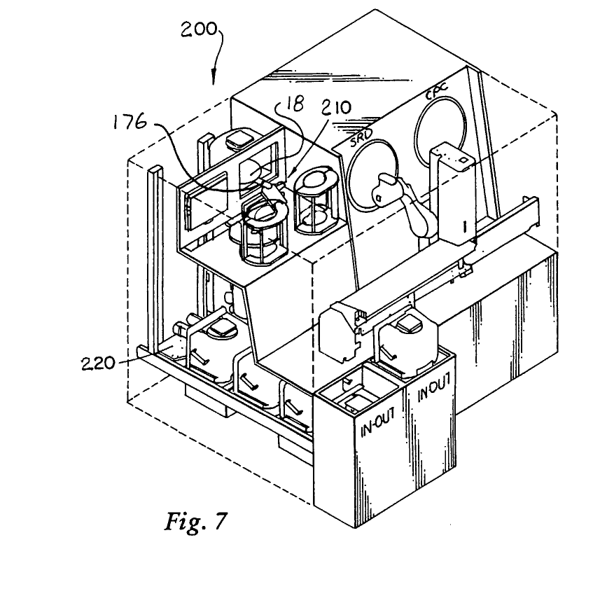

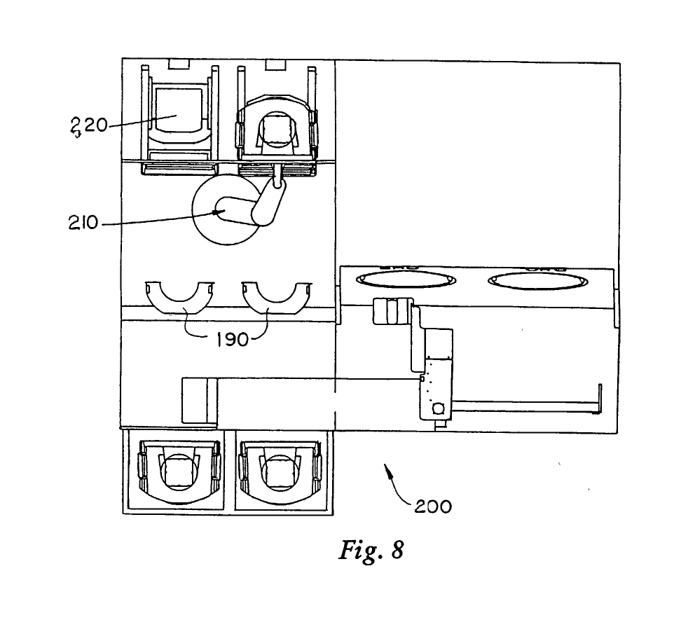

As shown in FIGS. 7 and 8, in an alternative embodiment 300, a single transfer robot 310 is provided, instead of the two transfer robots 170 shown in FIGS. 1-6. In addition, the pod rotator 320 is provided on the elevator conveyors 102 at pod positions R and S, rather than in the loader 24.

Referring to FIGS. 1-6, and end effector 205 attached to the articulated arm 204 of the process robot 200 is adopted to engage the carriers 190. The end effector 205 has a pair of spaced apart blade-like fingers 206 which engage slots in the sides of the carriers 190. Hence, the process robot 200 can engage, lift, maneuver, and place the carriers 190 holding the wafers 18.

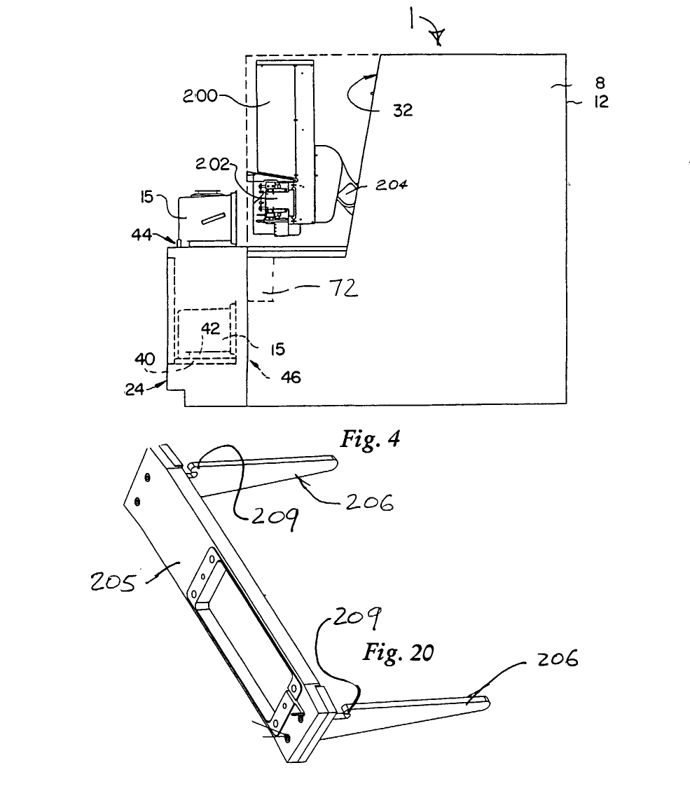

In use, with reference to FIGS. 1 and 2, an operator carries or transfers a pod 15 to the loader 24, preferably by holding the handles 17. An automated or robotic pod delivery system may also be used to deliver a pod 15 to the loader 24. The pod 15 is placed onto the load elevator 38. The controller 72 is preferably pre-programmed with a specific wafer processing and handling sequence. The elevator 38 lowers the pod from the up or load position 44 to the down or indexer position 46, as shown in FIG. 4.

The wafers 18 are enclosed, and generally sealed within the pod 15, to protect the wafers 18 from contamination and damage during handling and movement. The pod door 16 closes or seals off the open front end of the pod 15, as is well known.

With the pod 15 at the front pod position M shown in FIG. 2, the conveyor section 50 supporting the pod 15 is actuated. The drive rollers 102 drive the pod 15 rearwardly, while idler rollers help to support the pod 15, thereby moving the pod 15 from the conveyor section 50 to pod position K in the indexer 26. The conveyor sections 50 are at the same vertical level as the indexer conveyors 64 and 66, as well as the docking elevator conveyors 102.

In most applications, multiple pods 15 will be loaded into the indexer 26 and system 1, although the system may also operate with just a single pod 15. In a typical operating sequence, additional pods 15 are loaded into the indexer 26, as described above. As each subsequent pod 15 is loaded, drive rollers in the conveyor 64 in the load row 60 of the indexer 26 are actuated. Thus, the pod 16 at pod position K is moved back by the conveyor 64 to the docking elevator conveyor 102.

The elevator 102 then lifts the pod 15 off of the conveyor 102 and raises the pod vertically up to the docking station 28. Specifically, the engager plate 110 on the elevator 100 engaging corresponding holes in the bottom of the pod 15.

Once the pod 15 is raised to the level of the docking station 28, the engager actuator 112 moves the pod 15 forward, so that the front surface of the pod contacts the docking wall 114, to dock the pod. The pod door remover 130 engages the pod door 16 through the opening 116 in the docking wall 114. Suction cups on the pod door remover 130 hold the pod door 16 onto the pod door remover 130, while keys extend into the pod door 16 and rotate, to unlock or release the latching mechanism which holds the pod door 16 onto the pod 15. The pod door remover 130 then moves forward, carrying the pod door 16 with it through the opening 116. The pod door remover 130, carrying the pod door 16 then moves down through the door slot 134. The front of the pod 15 is then opened to the process space 22.

The transfer robot 170 in the transfer station 30 moves so that the end effector 176 on the articulated arm 174 moves through the opening 116 to engage a wafer 18 within the pod 15. The robot 170 withdraws the wafer 18 from the pod 15 and places the wafer into the carrier 190, as shown in FIG. 2. The robot 170 optionally passes the wafer 18 over a reader/scanner 180, to allow the controller 72 to identify that wafer, e.g., via a bar code on the bottom surface of the wafer.

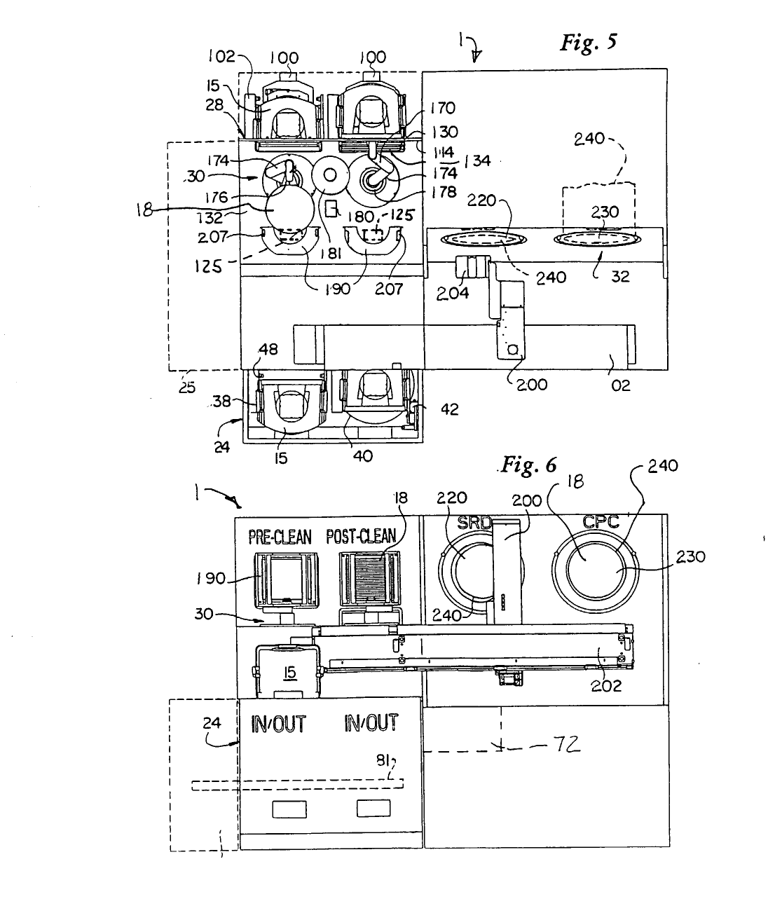

Referring to FIG. 5, preferably, the transfer robot 170 transfers wafers between the pod 15 in row CC and the carrier 190 in row CC which is aligned with that pod, in the longitudinal direction. While cross-over wafer transfer movement between rows CC and DD may optionally be carried out, such that a wafer is transferred to a carrier 190 diagonally opposed from the pod, straight or parallel wafer movement within each row CC and DD is preferred.

The transfer robot 170 continues transferring wafers from the docked pod 15 to the carrier 110, preferably until all wafers have been transferred from the pod 15. The pod 15 and carrier 110 typically hold 25 wafers.

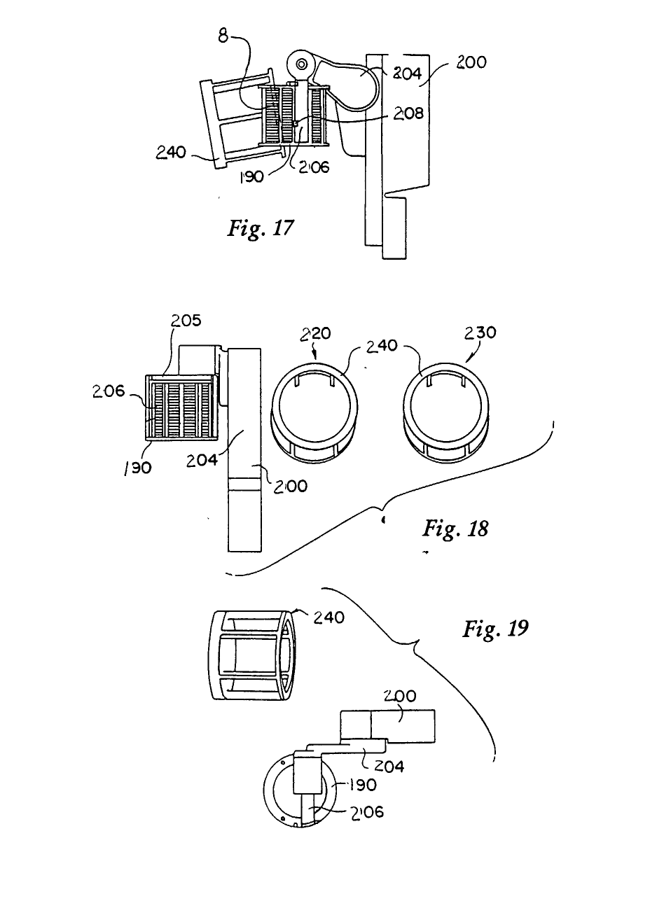

With the carrier 110 now loaded with wafers 18, the process robot 200 moves to engage the loaded carrier 190. Referring to FIGS. 17-20, the robot 200 moves laterally on the rail 202 so that the robot arm 204 is adjacent to the carrier 190. With the arm at an elevated position, the fingers 206 of the carrier end effector 205 are pointed down and are aligned with the finger slots 207 in the carriers 190. This alignment is performed by moving the robot to the proper position on the rail 202, and with proper control of the segments of the arm 204.

The arm 204 then moves vertically down, with the fingers 206 engaging into the slots 207 of the carrier 190. FIGS. 17-19 show the relative position of the arm 200, carrier 190, and rotors 240, for purposes of explanation. A locking pin 208, or other attachment device, is actuated, to positively secure the carrier 190 onto the end effector 205. The robot arm 204 then lifts up with the hooks 209 of the end carrier effector 205 engaging the hooks 308 on the carrier. The carrier 190 is lifted off of the deck 132, pivoted and moved forward (towards the front wall 6), and then moved laterally along the rail 202, to a position in alignment with the rotor 240 in one of the process chambers 220 or 230.

The rotors 240 are typically positioned on an inclined angle of about 10°. After the door of the process chamber 220 or 230 is open, the robot 200 moves the carrier 190 into engagement with the rotor 240. The securing device 208 is released or withdrawn, the arm 204 is pulled back out of the chamber 220 or 230, the chamber door is closed, and the wafers 18 are processed using known techniques.

After processing is complete, the robot 200 retrieves the carrier 190 from e.g., the process chamber 230, and installs it into a subsequent process chamber, such as process chamber 220. In the interim, the robot 200 may move back to the transfer station 30 and pick up another carrier 190 and place it into a process chamber for processing. When processing is complete, the robot 200 removes the carrier 190 from the last process chamber to be used, e.g., a spin rinser dryer process chamber, such as chamber 220, and then replaces the carrier 190 into the transfer station 30, typically in row DD. The transfer robot 170 in row DD then transfers the wafers 18 from the carrier 190 back into a docked pod 15, in row DD.

While two process chambers 220 and 230 are shown, the system 1 may operate with 1, 2, 3, or more process chambers.

After the loading of processed wafers into the pod 15 in row DD is complete, the pod door remover 130 replaces the pod door 16 onto the pod 15. The engager actuator 112 moves the pod back, to undock the pod from the docking wall 114. The elevator 100 then lowers the pod to position S, where the pod is supported on the docking elevator conveyor 102. The pod now holding processed wafers is then moved forward on the conveyor 66, into position BB on the unload elevator 40 of the loader 24. The pod is then rotated by the pod rotator 42 and lifted by the elevator 40 to the output position shown in FIG. 4. The operator then lifts the pod 15 off of the unload elevator 40 and carries the pod to the next station. Alternatively, the pod 15 may be removed from the unload elevator 40 by a robot or other automation.

In typical operation of the system 1, pods 15 cycle through the indexer 26, docking station 28, transfer station 30, and process station 32, in a step by step cycle, with the pods always moving forward through the cycle. However, for certain applications, the system 1 may be operated in other ways.

To reduce contamination, clean air flows downwardly, from top to bottom through the system 1. The deck 132 preferably has openings in it to allow air to flow downwardly. Alternatively, the deck 132 may be removed entirely, with air flow used to reduce contamination, rather than separation of spaces by a deck or wall. In an embodiment having no deck 132, the indexer space and process space are combined into a single system space. The docking wall 114 then serves as a surface for docking pods, rather than as a barrier to contamination.

By locating the indexer 26 largely underneath the docking station 28 and transfer station 30, a compact design requiring less floor space, is achieved.

The controller 72 is preferably electrically connected to the various robots, motors, sensors, and actuators involved in performing the functions of the system 1, so that the various components can be controlled in coordination and system performance controlled and monitored.

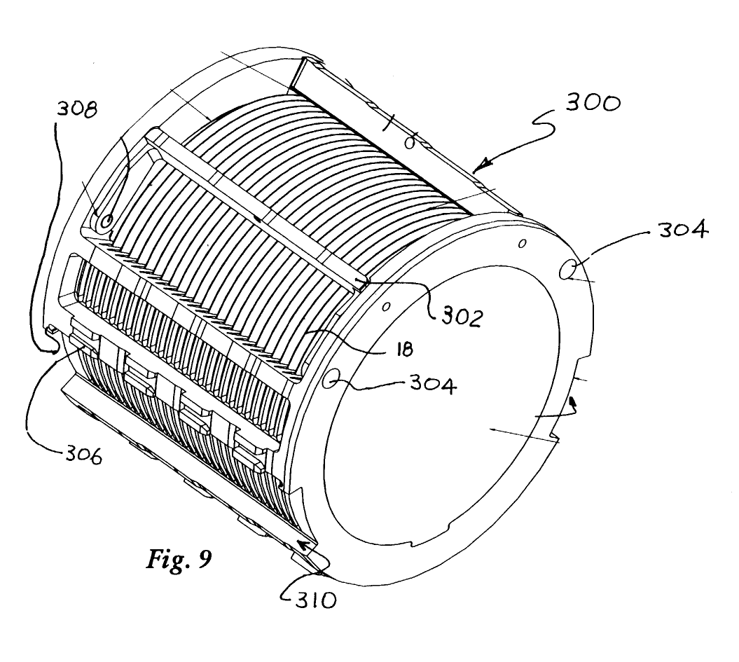

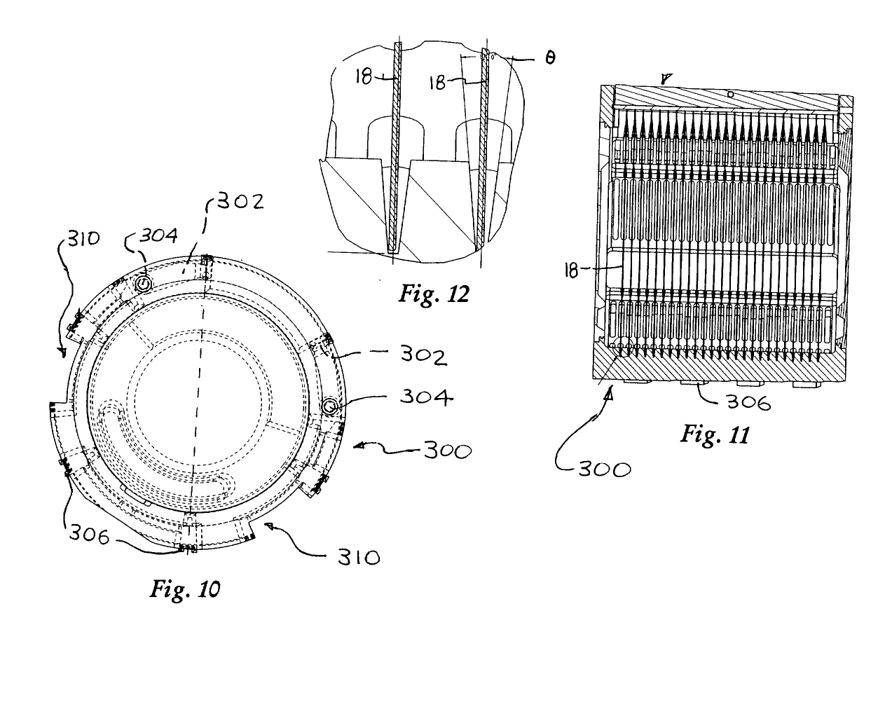

Referring to FIGS. 9-12, and alternative carrier 300 for use with the system show in FIGS. 1-6 or 7-8, has a pair of retainer bars 302 attached to the carrier 300 at front and rear pivot joints 304. Stepped lugs 306 on the outside of ribs of the carrier 300, engage with corresponding fittings in a rotor within the process chambers. The carrier 300 also has hook features 308 at its back end, and slots 310, so that the carrier 300 can be engaged, lifted and handled by the arms 190 of the process robot 200. The carrier 300, which is internally dimensioned to carry 300 mm diameter wafers, is further described in U.S. patent application Ser. No. 09/735,154, incorporated herein by reference.

While the semiconductor manufacturing industry is moving towards use of 300 mm diameter wafers, other size wafers, such as 200 mm diameter wafers, continue in widespread use. With the modifications described below, the systems shown in FIGS. 1-6 or 7-8, while nominally intended for processing 300 mm wafers, can also handle and process wafers of other sizes.

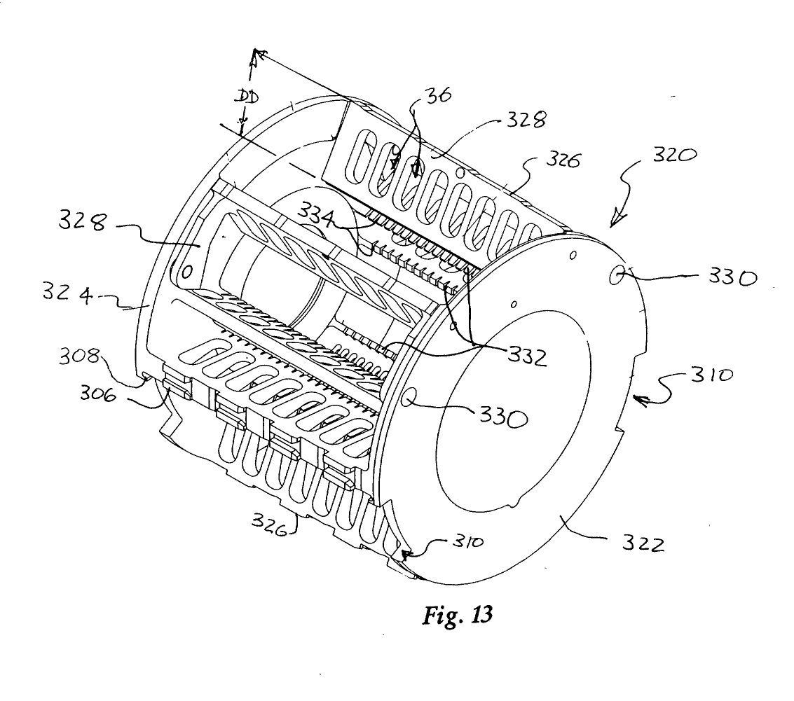

Referring to FIG. 13, an alternative rotor 320 for use with the systems shown in FIGS. 1-6 or 7-8 has external features which are similar or the same as those shown in the carrier of FIG. 9. Consequently, the carrier 320 can be used in place of the carrier 300 (or 190), without adversely affecting operation of the system 1 or 200. Specifically, because the outside engagement features of the carriers 300 and 320 are the same, either can be engaged, held or moved securely by the process robot or the rotors. The outside engagement features include one or more of: the outside diameter of the carrier, or of the front ring 322 and rear ring 324 of the carrier 320; the stepped ribs 326, the stepped ribs on the retainer bars 328, the hooks 308, and the slots 310. The end effector 206 of the process robot 200 is able to engage, lift, move, place, or otherwise handle the carrier 320 in the same way as the carriers 190 or 300.

However, the carrier 320, as shown in FIG. 13, has interior wafer holding features adapted to hold wafers of a smaller size, for example, 200 mm wafers. Specifically, the carrier 320 has combs 332 on the inside facing surfaces of ribs 326, with the combs having slots 334, for holding 200 mm diameter wafers. In comparison with the carrier 300, the combs 332 and slots 334 in the carrier 320 shown in FIG. 13 are moved radially inwardly, by increasing the radial depth or distance of the ribs 326 and retainer bars 328. The depth or inward radial projection of the ribs 326 and retainer bars 328, shown as DD in FIG. 13, is selected so that the combs 332 securely hold a smaller wafer, in comparison to the carrier 300 shown in FIG. 9. Clearance openings 336 are optionally provided in the ribs 326 and retainer bars 328, to reduce the weight of the carrier 320, and also to allow process chemicals to better move through the carrier. The retainer bar opening and closing mechanism 125 in the transfer station in the systems 1 and 200, operates on both carriers 300 and 320 as the retainer bars of the rotors 300 and 320 are at the same spatial position in the transfer station, when the carriers are located in the transfer station, as shown in FIG. 2.

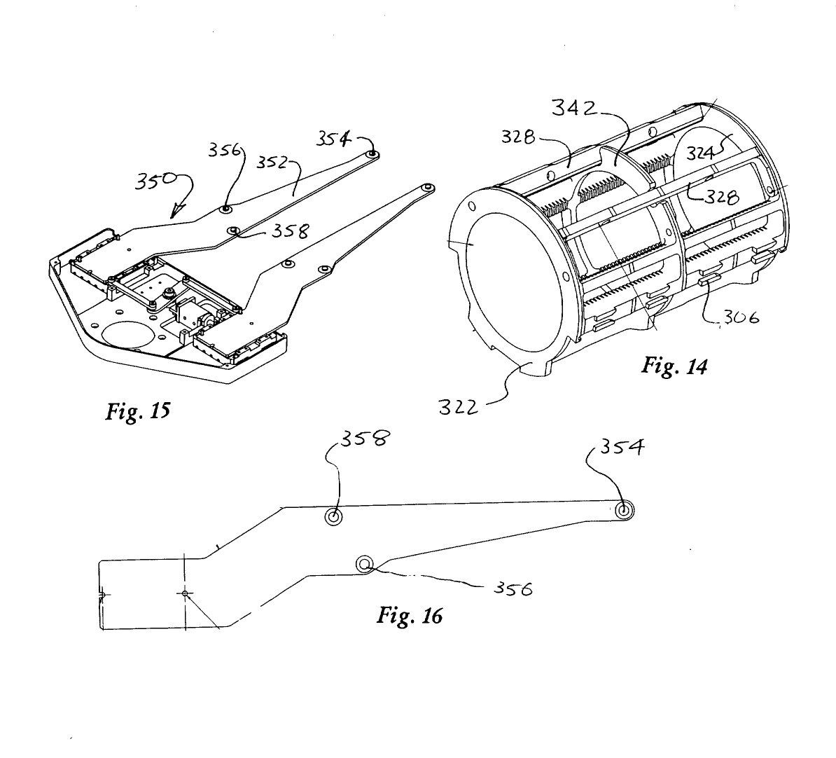

FIG. 14 shows another carrier 340, similar to carriers 300 and 320, and further including a central ring 342. The carrier 340 has additional wafer holding positions, and may be used in the systems 1 and 200 having rotors 240 in the process chambers adapted to receive the longer carrier 340.

To use the systems 1 or 200 with an alternative size wafer, in addition to replacing the carriers 190 or 300 with the smaller wafer size carrier 320, the end effector 176 on the transfer robot 170 is modified so that the transfer robot can handle wafers of either size. Referring to FIGS. 15 and 16, an alternative end effector 350 is provided to replace the end effector 176, shown in FIG. 7, when operation of the systems 1 or 200 with varying wafer sizes is desired. The end effector 350 is described in U.S. Pat. application Ser. No. 09/907,523, incorporated herein by reference. In addition, the arms, which are mirror images of each other, are each provided with first, second and third wafer or workpiece contacts, 354, 356 and 358. As shown in FIG. 16, the workpiece contacts or inserts 354, 356 and 358 are configured in an elongated triangle on each of the arms 352. This allows the arms to engage and move wafers of either size.

Thus, a novel process system has been shown and described. Various changes and substitutions can of course be made without departing from the spirit and scope of the invention. The invention, therefore, should not be limited, except to the following claims, and their equivalents.

What is claimed is:

1. A method for processing first workpieces having a first size and for processing second workpieces having a second size different from the first size, comprising the steps of:
loading the first workpieces into a first carrier having internal features dimensioned to hold the first workpieces, and having a first external element for engagement with a robot;
loading the second workpieces into a second carrier having internal features dimensioned to hold the second workpieces, and having a second external element for engagement with the robot, and with the second external element the same as the first external element;
engaging the first carrier with the robot and placing the first carrier into a process chamber; and
engaging the second carrier with the robot and placing the second carrier into a process chamber.

2. The method of claim 1 wherein the external element comprises a hook.

3. The method of claim 1 wherein the external element comprises a diameter of a ring.

4. The method of claim 1 wherein the external element comprises a plurality of stepped ribs.

5. A system for processing first workpieces or a first diameter, and for processing second workpieces of a second diameter different from the first diameter, comprising:
a first carrier and a second carrier;
a robot for engaging and moving the first carrier and the second carrier;
with the first carrier having internal features dimensioned to hold the first workpieces, and having a first external element for engagement with the robot;
and with the second carrier having internal features dimensioned to hold the second workpieces, and with the second carrier also having the first external element for engagement with the robot.
